SEQUENCE LISTING (10 sequences)

SEQ ID NO: 1 - DNA, 27 bp, Artificial
  Synthetic
cgtctctacctgattactattgcatct

SEQ ID NO: 2 - DNA, 27 bp, Artificial
  Synthetic
agatgcaatagtaatcaggtagagacg

SEQ ID NO: 3 - DNA, 39 bp, Artificial
  Synthetic
tggaattaggccagtagtatcaactcaactgctgttaaa

SEQ ID NO: 4 - DNA, 21 bp, Artificial
  Synthetic
cactgtggttggtgtggttgg

SEQ ID NO: 5 - DNA, 21 bp, Artificial
  Synthetic
ccaaccacaccaaccacagtg

SEQ ID NO: 6 - DNA, 32 bp, Artificial
  Synthetic
cactgacctgggggagtattgcggaggaaggt

SEQ ID NO: 7 - DNA, 32 bp, Artificial
  Synthetic
accttcctccgcaatactcccccaggtcagtg

SEQ ID NO: 8 - DNA, 15 bp, Artificial
  Synthetic
ggttggtgtggttgg

SEQ ID NO: 9 - DNA, 15 bp, Artificial
  Synthetic
ttttttntttttttt

SEQ ID NO: 10 - DNA, 39 bp, Artificial
  Synthetic
tttaacagcagttgagttgatactactggcctaattcca

(19) United States
(12) Patent Application Publication
(10) Pub. No.: US 2010/0009868 A1
(43) Pub. Date: Jan. 14, 2010

(54) Self-Assembled Combinatorial Encoding Nanoarrays for Multiplexed Biosensing

(75) Inventors: Hao Yan, Chandler, AZ (US); Chenxiang Lin, Tempe, AZ (US); Evaldas Katilius, Superior, AZ (US); Yan Liu, Chandler, AZ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: The Arizona Board of Regents a body corporate acti ng for and behalf of Arizona State university, Scottsdale, AZ (US)

(21) Appl. No.: 12/374,259

(22) PCT Filed: Sep. 11, 2007
(86) PCT No.: PCT/US07/78174

§ 371 Date: Sep. 3, 2009

Related U.S. Application Data
(60) Provisional application No. 60/843,588, filed on Sep. 11, 2006.
(60) Provisional application No. 60/843,712, filed on Sep. 11, 2006.
(60) Provisional application No. 60/846,539, filed on Sep. 22, 2006.
(60) Provisional application No. 60/846,591, filed on Sep. 22, 2006.

(51) Int. Cl. C40B 30/10; C40B 40/08; C40B 50/18

(52) U.S. Cl. 506/12; 506/17; 506/32

(57) ABSTRACT

The present invention provides combinatorial encoding nucleic acid tiling arrays and methods for their use and synthesis.

### CROSS REFERENCE

This application claims priority to U.S. Provisional Patent Applications 60/843588 filed Sep. 11, 2006, 60/843712 filed Sep. 11, 2006, 60/846,591 filed Sep. 22, 2006, and 60/846,539 filed Sep. 22, 2006, incorporated by reference herein in their entirety.

### STATEMENT OF GOVERNMENT INTEREST

This was supported by grants from the National Science Foundation awards CCF-0453685, CCF-0453686, CTC-0545652 and AFOSR FA95500710080, and thus the U.S. government has certain rights in the invention.

### BACKGROUND OF THE INVENTION

Barcodes are common in our daily life for tracking information. Similarly, if an individual biological recognition event can be encoded by a highly specific molecular barcode, one can build nanoscale multiplexed sensing arrays to determine the identity of a large number of different molecular species in a single solution and small sample volume. Most of the current encoding methods utilize chip-based (1) or particle-based platforms (2-4), incorporating a large number of probes for proteins or nucleic acids that are immobilized on a solid support in a spatially or spectrally addressable manner. The construction of synthetic nano-architectures based on DNA tile self-assembly has seen rapid progress in the past few years (5). DNA is an ideal structural material due to its innate ability to self-assemble into highly ordered nanoscale structures based on the simple rules of Watson-Crick base pairing. Recently, it has been demonstrated that DNA tile molecules can self-assemble into millimeter sized 2-D lattice domains made from billions to trillions of individual building blocks (6). A unique advantage of these self-assembled DNA tile arrays is the ability to assemble molecular probes with precisely controlled distances and relatively fixed spatial orientations.

It would be of great value in the art to develop nucleic acid tile-based combinatorial encoding arrays with built-in barcodes.

### SUMMARY OF THE INVENTION

In a first aspect, the present invention provides combinatorial encoding nucleic acid tiling arrays comprising:

(a) a plurality of linker tiles;

(b) a plurality of encoding tiles bound to the linker tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and

(c) one or more anchors bound to the nucleic acid tiling array, wherein the anchor is designed to bind a probe of interest so that the probe is displaceable in the presence of target for the probe, wherein the one or more anchors are bound to linker tiles, encoding tiles, or both.

In a further embodiment, the nucleic acid tiling arrays further comprise one or more probe populations bound to the one or more anchors; wherein each probe population comprises one or more probes; wherein each probe in a given population is spectrally distinguishable from the probes in different probe populations; wherein each probe is labeled with the first fluorophore, the second fluorophore, the third fluorophore, or a linker tile fluorophore that is spectrally distinguishable from the first, second, and third fluorophores; wherein the one or more probes are bound to the anchor so as to be displaceable from the anchor in the presence of target for the probe; and wherein probe displacement causes a change in fluorescence of the array.

In a second aspect, the present invention provides combinatorial encoding nucleic acid tiling array systems comprising a plurality of combinatorial encoding nucleic acid tiling arrays of the invention, wherein the plurality of combinatorial encoding nucleic acid tiling arrays comprises combinatorial encoding nucleic acid tiling arrays of different (a) probes; and (b) fluorescent barcodes, wherein a given fluorescent barcode level corresponds to a specific probe.

In a further aspect, the present invention provides methods for detecting the presence of one or more targets in a sample, comprising
(a) contacting the combinatorial nucleic acid tiling array or combinatorial encoding nucleic acid tiling array system of the invention with a test sample under conditions suitable for binding of the one or more probes to its target if present in the test sample and under conditions suitable for causing displacement of the probe from the anchor by the target; and
(b) detecting a change in a fluorescence emission pattern from the combinatorial nucleic acid tiling arrays or combinatorial encoding nucleic acid tiling array system caused by displacement of the probe from the anchor, wherein the change in fluorescence emission pattern indicates presence of the target in the test sample.

In a further aspect, the present invention provides methods for making a combinatorial nucleic acid tiling array, comprising combining a plurality of linker tiles and a plurality of encoding tiles under conditions suitable to promote base pairing of the linker tiles to the encoding tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and wherein one or more anchors are bound to the nucleic acid tiling array, wherein the one or more anchors are designed to bind a probe of interest so that the probe is displaceable in the presence of target for the probe, wherein the one or more anchors are bound to linker tiles, encoding tiles, or both.

### BRIEF DESCRIPTION OF THE FIGURES

FIG. 1. Schematic drawings of one embodiment of the combinatorial detection nanoarrays where the linker tile does not include a probe and encoding tiles 1 and 2 both contain labeled probes that are spectrally distinguishable. ‘Red” is denoted by a cross-grid pattern; “green” is denoted by a strip pattern, and “blue” is denoted by a solid pattern. Mixed colors are noted by name. The lattices can continue to grow much larger, although only a small fragment is illustrated.

FIG. 2. Schematic drawing of a strand displacement detection mechanism.

FIG. 3. Detection of 4 types of targets using the preliminary design. a) array assembled from A1:A2:B=1:1:2, A1 carries red dye and A2 carries green, the array shows yellow color when superimposed (see FIG. 1 for explanation of color codes). b) when SARS DNA target is added, its probe carrying a green dye got displaced off the array and only red color is left. c) When HIV DNA target is added, its probe carrying a red dye got displaced off the array and only red color is left. d) when thrombin protein is added, its aptamer probe carrying a green dye got displaced off the array and only red color is left. d) when ATP is added, its aptamer probe carrying a green dye got displaced off the array and only red color is left. (Scale bar in image: 30 μm)

FIG. 4. The design of self-assembled combinatorial encoding DNA arrays for multiplexed detection.

FIG. 5. Schematic drawing of the design and operation of the signaling aptamer array created by DNA tile self-assembly. a) The two tiles of the DNA nanogrid array. The dark tile contains the thrombin aptamer sequence in a G-quadruplex structure, at the 7th nucleic acid position, the original dT is substituted by the fluorescent nucleic acid analog 3MI. b) The molecular structure of 3MI. It is also labeled as a black star in the tile without protein. c) The self-assembly of the two-tile system into 2D array that displays the thrombin-binding aptamer at every other DNA tile. Upon protein binding, the array containing the signaling aptamers ‘lights up’.

### DETAILED DESCRIPTION OF THE INVENTION

All publications, patents and patent applications cited herein are hereby expressly incorporated by reference for all purposes.

Within this application, unless otherwise stated, the techniques utilized may be found in any of several well-known references such as: Molecular Cloning: A Laboratory Manual (Sambrook, et al., 1989, Cold Spring Harbor Laboratory Press) and PCR Protocols: A Guide to Methods and Applications (Innis, et al. 1990. Academic Press, San Diego, Calif.).

As used herein, the singular forms “a”, “an” and “the” include plural referents unless the context clearly dictates otherwise. For example, reference to a “nucleic acid” means one or more nucleic acids.

In a first aspect, the present invention provides combinatorial encoding nucleic acid tiling arrays comprising:

(a) a plurality of linker tiles;

(b) a plurality of encoding tiles bound to the linker tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and

(c) one or more anchors bound to the nucleic acid tiling array, wherein the anchor is designed to bind a probe of interest so that the probe is displaceable in the presence of target for the probe, wherein the one or more anchors are bound to linker tiles, encoding tiles, or both.

The nucleic acid tiling arrays of the present invention are self-assembling, combinatorial encoding nanoarrays that can be used for multiplexed detection of biologically relevant molecules. The arrays and systems of the invention provide massively parallel construction through nucleic acid self-assembly; water-solubility; easy attachment of molecular probes by nucleic acid hybridization; fast target binding kinetics due to accurate control of the spatial distance between the probes; and rechargeability for repeated use. The arrays can be used, for example, in regular research lab or clinic labs routinely for small to moderate scale protein profiling and gene expression detection.

The tiling arrays of the invention comprise at least 3 nucleic acid tiles. In various embodiments, the nucleic acid tiling arrays comprise at least 3, 4, 6, 8, 9, 12, 15, 18, 21, 24, 27, 30, 40, 50, 75, 100, or more nucleic acid tiles (ie: encoding tiles plus linker tiles). Nucleic acid tiles are known in the art. See, for example, Yan, H. et al., Science 2003, 301, 1882-1884; U.S. Pat. No. 6,255, 469; WO 97/41142; Seeman, N. C., Chem Biol, 2003. 10: p. 1151-9; Seeman, N. C. N., 2003. 421: p. 427-431; Winfree, E. et al., Nature, 1998. 394: p. 539-44; Fu, T. J. and N. C. Seeman, Biochemistry, 1993. 32: p. 3211-20; Seeman, N. C., J Theor Biol, 1982. 99: p. 237-47; Storhoff, J. J. and C. A. Mirkin, Chem. Rev., 1999. 99: p. 1849-1862; Yan et al., Proceedings of the National Academy of Sciences 100, Jul. 8, 2003 pp 8103-8108.) The present invention can use any type of nucleic acid tile, including but not limited to 4 arm branch junctions, 3 arm branch junctions, double crossovers, triple crossovers, parallelograms, 8 helix bundles, 6 helix bundle-tube formations, and structures assembled using one or more long “thread” strands of nucleic acid that are folded with the help of smaller ‘helper’ strands (See WO2006/124089 for thread strand based tiling arrays).

The dimensions of a given nucleic acid tile can be programmed, based on the length of the core polynucleotides and their programmed shape and size, the length of the sticky ends (when used), and other design elements. Based on the teachings herein, those of skill in the art can prepare nucleic acid tiles of any desired size. In various embodiments the length and width of individual nucleic acid tiles are between 3 nm and 100 nm; in various other embodiments, widths range from 4 nm to 60 nm and lengths range from 10 nm to 90 nm.

The dimensions of the resulting nucleic acid tiling array can also be programmed with the use of boundary tiles (ie: tiles designed to terminate further assembly of the array), depending on the size of the individual nucleic acid tiles, the number of nucleic acid tiles, the length of the sticky ends (when used), the desired spacing between individual nucleic acid tiles, and other design elements. In embodiments that do not incorporate boundary tiles, the size of the arrays depends on the purity of the DNA strands, the stoichiometry of the different polynucleotides, and the kinetics (how slow the annealing process is). Based on the teachings herein, those of skill in the art can prepare nucleic acid tiling arrays of any desired size, including arrays of at least 1 -10 μm in length (ie: 1×1 μm² to 10×10 μm²), and up to mm sized arrays.

As used herein, “nucleic acid” means DNA, RNA, peptide nucleic acids (“PNA”), 2′-5′ DNA (a synthetic material with a shortened backbone that has a base-spacing that matches the A conformation of DNA; 2′-5′ DNA will not normally hybridize with DNA in the B form, but it will hybridize readily with RNA) and locked nucleic acids (“LNA”), nucleic acid-like structures, as well as combinations thereof and analogues thereof. Nucleic acid analogues include known analogues of natural nucleotides which have similar or improved binding properties. The term also encompasses nucleic-acid-like structures with synthetic backbones. DNA backbone analogues provided by the invention include phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs), methylphosphonate linkages or alternating methylphosphonate and phosphodiester linkages (Strauss-Soukup (1997) Biochemistry 36:8692-8698), and benzylphosphonate linkages, as discussed in U.S. Pat. No. 6,664,057; see also Oligonucleotides and Analogues, a Practical Approach, edited by F. Eckstein, IRL Press at Oxford University Press (1991); Antisense Strategies, Annals of the New York Academy of Sciences, Volume 600, Eds. Baserga and Denhardt (NYAS 1992); Milligan (1993) J. Med. Chem. 36:1923-1937; Antisense Research and Applications (1993, CRC Press).

Linker tiles are nucleic acid tiles that link encoding tiles together to form a two-dimensional pattern of linker tiles and encoding tiles. The plurality of linker tiles may comprise any suitable number of linker tiles based on a desired array design; in various non-limiting embodiments, the array may comprise 2, 3, 4, 5, 6, 7, 8, 9, 10, 15, 20, 50, 100, 1000, or more linker tiles. As discussed in more detail below, linker tiles may serve solely to pattern the encoding tiles into a desired array format, or may add functionality to the array by comprising a fluorophore (“linker fluorophore”) and/or anchor to bind probe. Any such linker fluorophores are spectrally distinguishable from any encoding tile fluorophores in the nucleic acid tiling array. For example, in embodiments where the linker tiles and encoding tiles are joined by sticky ends, the sticky ends are designed so that encoding tiles can only base pair with linker tiles and linker tiles base pair with encoding tiles to provide a desired pattern. The sticky ends can be designed to provide desired periodic distances between the encoding tiles, as well as between linker tiles and encoding tiles. The plurality of linker tiles in the nucleic acid tiling array can comprise all identical linker tiles, or may comprise different sub-populations of linker tiles, where each sub-population may comprise the same or spectrally distinct fluorophores from the other linker tiles and/or the same or different anchors or probe types (or all lack anchors or probes). In embodiments where the plurality of linker tiles all are of the same type, the linker tiles can bind only to encoding tiles to form the array. In embodiments where the plurality of linker tiles comprise two or more sub-populations of different types of linker tiles, a linker tile from one sub-population may be designed so as to bind linker tiles from a different sub-population of linker tiles, and/or designed to bind to encoding tiles.

Encoding tiles are nucleic acid tiles and always comprise a fluorophore, and may comprise an anchor for probe binding. The plurality of encoding tiles may comprise any suitable number of encoding tiles based on a desired array design; in various non-limiting embodiments, the array may comprise 2, 3, 4, 5, 6, 7, 8, 9, 10, 15, 20, 50, 100, 1000, or more encoding tiles. While the encoding tiles are always linked by linker tiles, the distance between different encoding tiles can be varied as desired by appropriate design of the linker tiles and sticky ends, as will be apparent to those of skill in the art based on the teachings and examples provided herein. The nucleic acid tiling arrays of the invention require at least two populations of encoding tiles, one or more first encoding tiles and one or more second encoding tiles, wherein each first encoding tile comprises a first fluorophore and each second encoding tile comprises a second fluorophore, wherein the first fluorophore and the second fluorophore are spectrally distinguishable. Thus, the first and second encoding tile populations present 2 different “colors.” Any number of encoding tile populations can be present in the nucleic acid tiling arrays of the invention (for example, 2, 3, 4, 5, 6, 7, or more different populations of encoding tiles), limited only by the requirement that each different encoding tile population is spectrally distinguishable from the other encoding tile populations. For example, the use of quantum dots as fluorophores permits construction of arrays with larger numbers of encoding tile populations. Similarly, any number of encoding tiles can be present in one population of encoding tiles as suitable for a particular purpose.

It will be understood by those of skill in the art that the nucleic acid tiling arrays may comprise other tiles or features as desirable for any given application including but not limited to control tiles of any desired type.

The anchors are nucleic acid extensions (ie: DNA or RNA) from core polynucleotide(s) of the encoding tiles and/or linker of the tiling array. The anchors are not involved in base pairing for nucleic acid tile assembly, and thus are available for binding to specific probes. In a preferred embodiment, each nucleic acid tile in the array designed to bind probe comprises at least one anchor per probe molecule to be bound. A given tile can comprise more than one anchor; in various embodiments, tiles that comprise an anchor comprise 1, 2, 3, 4, 5, or more anchors that can each be designed to bind to the same probe, different probes, or a combination thereof. Anchors are designed to bind a probe of interest so that the probe is displaceable in the presence of target for the probe (resulting in a change in fluorescence of the array, as described below); any suitable design can be used. The anchor and probe base pairing is stable enough to allow probe binding to target (so there is no negative detection), but is less stable than the probe-target complex, so that the leaving of the probe-target complex from the array is kinetically fast enough for detection. While it is preferable to design the anchor and probe so that their interaction occurs at a terminus of both, any portion of the anchor and probe can be designed for binding to the other.

In one non-limiting embodiment, an anchor is designed to base pair with only a portion of a nucleic acid probe. For example, where probe lengths range from 21 nucleotides to 39 nucleotides, the anchors may be designed to base pair over 8-12 base pairs with the probe. In another embodiment, the lengths of the DNA aptamer probes used are 15 and 27 bases, respectively, and 5-6 bases can be added to each at the 3′ end to make sure the binding of the aptamer probes to their protein or small molecule targets are not interfered with the pre-binding of the probes to the anchor. In another embodiment, the lengths of the probes for DNA targets are 27 and 39 bases to make them fully complementary to their DNA targets. The data presented herein demonstrates that a wide range of probe lengths can be used for detection of different targets. Probe length design and the amount of base-pairing between the probe and the anchor depends on the length of the target and can be determined by those of skill in the art. If a longer target is to be detected, a longer probe should also be used. In one embodiment, a base-paring region of 8-12 base-pairs between the probe and anchor are chosen because this length is known to be stable at room temperature, so there is no negative detection in the absence of target, while displacement of this length of base pairing interaction can be rapidly displaced in the presence of the targets upon formation of the probe-target duplexes of appropriate length (such as a between 21 to 39 base pairs).

In a further embodiment, the nucleic acid tiling arrays comprise one or more probe populations bound to the one or more anchors; wherein each probe population comprises one or more probes; wherein each probe in a given population is spectrally distinguishable from the probes in different probe populations; wherein each probe is labeled with the first fluorophore (ie: where the first fluorophore present in the first encoding tile population comprises probe bound to one or more anchors on the first encoding tile population), the second fluorophore (ie: where the second fluorophore present in the second encoding tile population comprises probe bound to one or more anchors on the second encoding tile population), the third (or further) encoding tile fluorophore (ie: where the nucleic acid tiling array comprises more than two populations of encoding tiles, and where the third or further fluorophore present in the third or further encoding tile population comprises probe bound to one or more anchors on the third or further encoding tile population), or one or more linker fluorophores (ie: where a linker fluorophore is present on probe bound to one or more anchors on a linker tile population); wherein the one or more probes are bound to the anchor so as to be displaceable from the anchor in presence of target for the probe; and wherein probe displacement causes a change in fluorescence of the array.

The rigidity and well-defined geometry of the nucleic acid tile structures provide superb spatial and orientational control of the probes on the array. The spacing of the probes and their positioning with respect to the tiling array surface can be precisely controlled to the sub-nanometer scale. This not only allows optimization of geometry for fast kinetics, it also allows efficient rebinding of the target to nearby probes and leads to improved binding efficiency. The sample is ready for imaging within 30 minutes after addition of the targets. The well separated positioning of the probes on the array also avoids quenching between dyes.

The probe can be any nucleic acid that can (a) bind to a target of interest, and (b) bind to the anchor so as to be displaceable from the anchor in the presence of target for the probe. A given tile can be designed to include anchors to bind a desired number of probes (whether from a single population of probes designed to bind to the same target, or to probes from different sub-populations designed to bind to different targets). Similarly, a given tile can comprise probes designed to bind to different anchors and target populations; in this embodiment, different probe populations are labeled with spectrally distinguishable fluorophores. The use of multiple identical probes on the same tile increases detection sensitivity. Multiple different probe populations on the same tile can be used, for example, to promote cooperative binding events by appropriate localization of the different probe types on the tiles.

A given tiling array can have 1, 2, 3, 4, 5, 6, 7, 8, 9, 10, 11, 12, 13, 14, 15, 16, 17, 18, 19, 20, or more probe populations, so long as an observer can distinguish a different color change of the array based on binding of each probe population to its target (and thus its displacement from the nucleic acid tiling array). Examples of probes can include single stranded or double stranded nucleic acid oligos for detection of DNA or RNA targets, or aptamers for detection of specific aptamer binding targets.

In one embodiment, the probe comprises a signaling aptamer, defined herein as an aptamer probe that couples target binding to fluorescent-signal generation. This is generally done by introducing a fluorophore in a region of the aptamer known to undergo environmental change upon target binding, such as conformational or polarity change, so the molecular recognition event can be transduced to detectable optical signals. In one embodiment, the aptamer sequence is synthesized with at least one nucleotide replaced by a fluorescent base analog, wherein the fluorescence intensity of the modified aptamer is detectably increased or decreased upon aptamer binding to ligand molecule. In other embodiments, different signaling aptamers in a given nucleic acid tiling array are labeled with fluorophores that emit fluorescence at different wavelengths for multi-color and multi-components detection. In other embodiments, two fluorophores are bound to the signaling aptamers at different places and the interaction between them is distance dependent. Upon target binding, the aptamer conformation and thus the distance between the fluorophores change. This can change the amounts of fluorescence emitted from two fluorophores (based on the amount of energy transfer between them) via a process known as fluorescence resonant energy transfer (FRET). In another embodiment, one fluorophore and one non-fluorescent quencher are bound to the signaling aptamers at different places and the interaction between them is distance dependent. Upon target binding, the aptamer conformation and thus the distance between the fluorophore and the non-fluorescent quencher changes, and thus can change the fluorescence intensity emitted from the fluorophore; this is normally based on energy transfer, though it can also be based on electron transfer, between the fluorophore and the non-fluorescent quencher. The signaling aptamers can be RNA or DNA, and can be single or double stranded. In one embodiment of the methods of the invention, the aptamers are 10-80 nucleotides in length. “Fluorescent nucleotide” or “fluorescent base analog” is a nucleotide or nucleotide analogue that is capable of producing fluorescence when excited with light of an appropriate wavelength. The fluorescence signal is greatly reduced or eliminated when the nucleotide is incorporated into an oligonucleotide and undergoes base stacking with neighboring bases. However, as long as the nucleotide analog fluoresces with a quantum yield above 0.04, more preferably above 0.1 and most preferably above 0.15 when it exists as a monomer in an aqueous solution it is regarded as a fluorescent nucleotide. Fluorescent nucleotides include, but not limited to, 2-amino purine (2AP), 3-methyl-isoxanthopterin (3MI), 6-methylisoxanthopterin (6MI), 4-amino-6-methyl-pteridone (6MAP), 4-amino-2,6-dimethyl-pteridone (DMAP), pyrrolo-dC, 5-methyl-2-pyrimidone.

The target can be anything that can be detected via binding to nucleic acids and aptamers, including but not limited to nucleic acids (RNA or DNA), polypeptides, lipids, carbohydrates, other organic molecules, inorganic molecules, metallic particles, magnets, quantum dots, and combinations thereof.

As will also be apparent to those of skill in the art, based on the teachings herein, the nucleic acid probe-containing tiles in an array may all contain the same nucleic acid probe, may all contain different nucleic acid probes, or a mixture thereof. As a result, the targets for binding to the nucleic acid probes can be the same for all nucleic acid tiles in a given nucleic acid tiling array, all different, or mixtures thereof. In a preferred embodiment, each of the nucleic acid probe-containing nucleic acid tiles comprises more than one nucleic acid probe, which can be the same probe population or members of different probe populations.

In various embodiments, one or more of the tiles in the tiling array comprises a probe; a majority of the tiles in the array comprise a probe; or all of the tiles comprise a probe with the optional exception of a small percentage of the tiles to serve as control tiles.

Any technique for binding of the probe to the anchor so as to make the probe displaceable in the presence of target for the probe can be used. In a non-limiting example, the anchor and probe are designed to result in strand displacement upon binding of target by the probe, as discussed above. This occurs because the target binding to the probe initiates a branch migration between the probe(s) and the anchor(s) on the tile. This is “fueled” by the free energy released from the fully complementary base pairing between a nucleic acid probe and its target nucleic acid, or, for example, a stronger binding between a nucleic acid aptamer and its specific target molecule. This is discussed in more detail in the examples that follow.

The fluorophores can be any such fluorophore that can be bound to the nucleic acid tiling arrays, are spectrally distinguishable, and which can be detected using standard detection methods. As will be understood by those of skill in the art, the fluorescence that can be detected from a given array can be measured by the specific fluorescence emission (wavelength), and/or its intensity (concentration of the fluorophore). Different colored dyes or more intensity levels can be used for creating larger scale barcoded arrays. Due to the small stock shift of organic dyes, introducing more types of dyes with different emission colors requires multiple excitation wavelengths and multiple excitation light sources, which imposes a potential instrumental limit. Using three different colored dyes (one for probe and two for encoding), with five intensity levels (0,1,2,3,4) for the two encoding dyes, one can create up to 13 different codes. However, the number of dyes that can be used is limited because the overlap of the dye emission spectra makes the deconvolution of the emission from different dyes challenging, and the different excitation of the dye requires multi-excitation wavelengths, which requires more sophisticated instrumentation for the detection. The number of intensity levels that can be implemented is limited by the distribution of the dye-labeled tiles into the different array domains and the domain sizes. Appropriate sticky ends can be designed for the encoding tiles and linker tiles, so that their incorporation into the tiling array can be perfectly controlled. With even distribution of the tiles in the array, the larger the sizes of the array domains, the more exact the intensity ratios of the encoding dyes that can be obtained, therefore the more intensity levels one can implement for the encoding.

In a preferred embodiment, the fluorophores for use in the nucleic acid tiling arrays of the present invention comprise quantum dots (QDs), also referred to as semiconductor nanoparticles, as is known in the art (For example, see Alivasatos, Science 271:933-937 (1996)). Non-limiting examples of QDs include: CdS quantum dots, CdSe quantum dots, CdSe@CdS core/shell quantum dots, CdSe@ZnS core/shell quantum dots, CdTe quantum dots, PbS quantum dots, and/or PbSe quantum dots. QDs, for example those in the 2-6 nm size range, are promising materials for multiplex biodetection not only because of their unique size-dependent optical properties but also because of their dimensional similarities with biological macromolecules (e.g. nucleic acids and proteins). QDs are often composed of atoms from groups II-VI or III-V elements in the periodic table, and are defined as particles with physical dimensions smaller than the exciton Bohr radius. Recent advances have enabled the synthesis of highly luminescent QDs in large quantities and the preparation of water-soluble biocompatible QDs. In comparison with organic fluorophores and fluorescent proteins, QDs offer the following advantages that make them appealing as fluorescent labels for use in the present invention:

1) the fluorescence emission spectra of QDs can be continuously tuned by changing the particle size, and a single wavelength can be used for simultaneous excitation of all different-sized QDs, which greatly simplifies the experimental instrument requirements;

2) surface-passivated QDs have narrow and symmetric emission peaks, which makes for easy spectral deconvolution and unambiguous data analysis;

3) QDs have higher absorbance cross section (per particle versus per dye molecule) and high fluorescence emission quantum yield, which means much brighter images with low background (high signal to noise ratio);

4) QDs have high resistance to photobleaching and exceptional resistance to photo- and chemical degradation, so the detection systems based on QD can have a much longer active life cycle, e.g. can be recharged many times.

In various embodiments, the fluorophore can be bound directly to the nucleic acid tile (ie: to the polynucleotide core of individual tiles or to an extension off of the core polynucleotide), or may be bound to the probe, which is then bound to the tiles via the anchor.

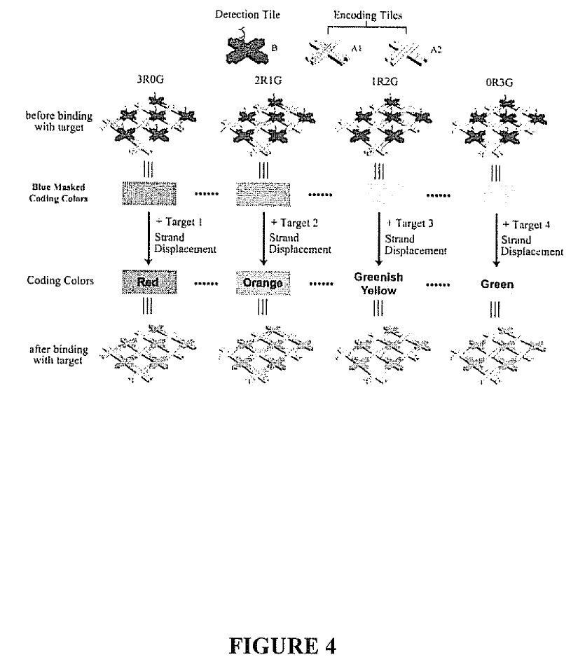

In one embodiment described below, linker tiles comprise one or more anchor-bound probes linked to a fluorophore that is spectrally distinguishable from the encoding tile fluorophores; in this embodiment, the linker tile comprises a detection tile, while the encoding tile fluorophores help to generate a barcode for the tiling array. In this embodiment, the encoding tile fluorophores may be directly bound to the tile polynucleotide core. In a further embodiment, the encoding tiles do not comprise probes. FIG. 4 provides a non-limiting illustration of this embodiment, in which the combinatorial encoding nucleic acid tiling array system includes the following: 1) An A1 encoding tile (“red” dye labeled) and an A2 encoding tile (“green” dye labeled) are annealed separately, and then mixed together at various molar ratios in different tubes to generate a combinatorial series of barcoded mixtures, e.g. 3R0G, 2R1G, 1R2G, and 0R3G; the encoding tiles are designed so that they cannot anneal with other encoding tiles; 2) Different probes all labeled by the same “blue” dye are annealed into B linker tiles in the different combinatorial series of barcoded mixtures; 3) By mixing the A1 and A2 encoding tiles with the B linker tiles one to one correspondingly in separate tubes in a ratio of (A1+A2):B=1:1, the A1 and A2 encoding tiles will associate with the B linker tiles to grow into 2-D arrays. With this approach, a modular system of encoding arrays is set up, with each array carrying a unique probe and displaying a unique barcode color. Details of methods for using tiling arrays according to this embodiment are provided below.

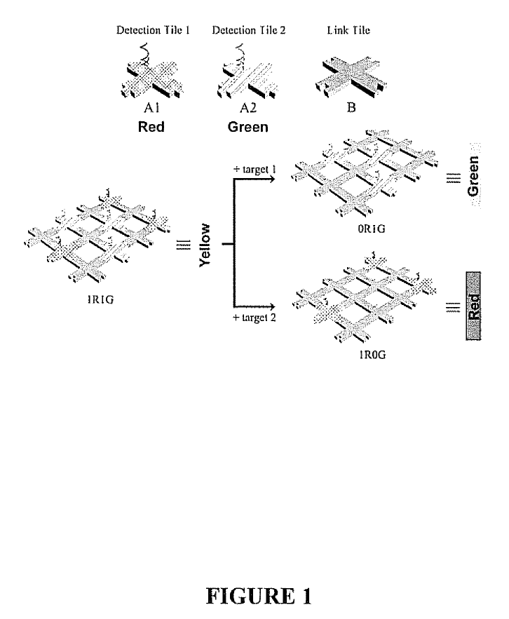

In a further embodiment, the linker tiles do not comprise probe or fluorophore, and two populations of encoding tiles are present, with each population of encoding tiles comprising one or more probes bound to fluorophore(s) that are spectrally distinguishable from the fluorophore of the other population of encoding tiles. In this embodiment (exemplified in FIG. 1), the linker tiles serve only to provide the desired pattern to the encoding tiles, and thus one or more encoding tiles on the array comprise a probe bound to one or more anchors on the encoding tile(s). Alternatively, one or more linker tiles may also comprise probe bound to one or more anchors on the linker tile(s) and/or also comprise a fluorophore (spectrally distinguishable from the encoding tile fluorophores) either bound directly to the one or more linker tiles, or bound to the probe bound to one or more anchors on the linker tile(s), and thus provide for further functionality of the arrays.

The data presented herein demonstrate that a spectrum of barcoded nucleic acid tiling arrays can be generated by tuning the ratio between the different fluorophores. The number of possible barcodes can be generated are limited only by the number of fluorophores that can be used and the number of relative intensity levels that can be implemented, as discussed in more detail below. Thus, in a further aspect, the present invention provides combinatorial encoding nucleic acid tiling array systems comprising a plurality of probe-containing combinatorial encoding nucleic acid tiling arrays of the invention, wherein each combinatorial encoding nucleic acid tiling arrays defines a fluorescent barcode, wherein a given fluorescent barcode corresponds to a specific probe, and wherein the plurality of probe-containing combinatorial encoding nucleic acid tiling arrays define a plurality of different barcodes. The system thus comprises combinatorial encoding nucleic acid tiling arrays defining at least two different barcodes; in various embodiments, the system comprises combinatorial encoding nucleic acid tiling arrays defining at least 3, 4, 5, 6, 7, 8, 9, 10, 25, 50, 100, 1000, or more different barcodes. Since each barcode corresponds to a specific probe, the systems of the invention can be used for multiplex detection assays of any sort, as will be apparent to those of skill in the art based on the teachings herein. As noted above, a “barcode” is the ratio of specific fluorescence emission (wavelength), and/or its intensity (concentration of the fluorophore) emitted from a given array. As will be understood by those of skill in the art, such intensity measurements can be either relative intensities or absolute intensities. Details on making combinatorial encoding nucleic acid tiling arrays of different barcodes are provided herein.

The nucleic acid tiling arrays of the invention can be made and stored as described herein. In various embodiments, the nucleic acid tiling array may be present in solution, in lyophilized form, or attached to a substrate. Non-limiting examples of substrates to which the nucleic acid tiling arrays can be attached include silicon, quartz, other piezoelectric materials such as langasite (La₃Ga₅SiO₁₄), nitrocellulose, nylon, glass, diazotized membranes (paper or nylon), polyformaldehyde, cellulose, cellulose acetate, paper, ceramics, metals, metalloids, semiconductive materials, coated beads, magnetic particles; plastics such as polyethylene, polypropylene, and polystyrene; and gel-forming materials, such as proteins (e.g., gelatins), lipopolysaccharides, silicates, agarose and polyacrylamides.

The nucleic acid tiling arrays of the invention can be attached to such surfaces using any means in the art. For example, one simple way to do this is with multiply charged cations (Mg, Ni, Cu etc.) that spontaneously attach to a negative surface like glass or mica, leaving extra charge to attach the nucleic acid. Another way to do this is with singly charged cations that are tethered to the surface chemically. An example would be aminopropyltriethoxysilane reacted with a surface containing hydroxyl groups. This leaves a positively charged amino group on the surface at neutral pH.

In another aspect, the present invention comprises methods for making the nucleic acid tiling arrays of the present invention. In this aspect, the methods comprise combining a plurality of linker tiles and a plurality of encoding tiles under conditions suitable to promote base pairing of the linker tiles to the encoding tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and wherein one or more anchors are bound to the nucleic acid tiling array, wherein the one or more anchors are designed to bind a probe of interest so that the probe is displaceable in the presence of target for the probe, wherein the one or more anchors are bound to linker tiles, encoding tiles, or both.

In a further embodiment, the method comprises binding one or more probes to the one or more anchors so that the probe is displaceable from the anchor in the presence of target for the probe. The binding is done under conditions suitable for promoting specific binding of the one or more probes to the one or more anchors. Specifics on probe displacement are discussed above.

The polynucleotide cores and anchors of the encoding and linking tiles may be made by methods known in the art. See, for example, Yan, H. et al., Science 2003, 301, 1882-1884; U.S. Pat. No. 6,255, 469; WO 97/41142; Seeman, N. C., Chem Biol, 2003. 10: p. 1151-9; Seeman, N. C. N., 2003. 421: p. 427-431; Winfree, E. et al., Nature, 1998. 394: p. 539-44; Fu, T. J. and N. C. Seeman, Biochemistry, 1993. 32: p. 3211-20; Seeman, N. C., J Theor Biol, 1982. 99: p. 237-47; Storhoff, J. J. and C. A. Mirkin, Chem. Rev., 1999. 99: p. 1849-1862; Yan et al., PNAS 100, Jul. 8, 2003 pp 8103-8108); and WO2006/124089. Synthesis of polynucleotides is well known in the art. It is preferable in making the polynucleotides for the nucleic acid tiles to appropriately design sequences to minimize undesired base pairing and undesired secondary structure formation. Computer programs for such purposes are well known in the art. (See, for example, Seeman, N. C., J Biomol Struct Dyn, 1990. 8: p. 573-81). It is further preferred that the polynucleotides are purified prior to nucleic acid tile assembly. Purification can be by any appropriate means, such as by gel electrophoretic techniques.

In one embodiment, the polynucleotide core and anchors for a given tile are self-assembled by nucleic acid hybridization of appropriately designed oligonucleotides under conditions to promote the desired base pairing reactions. Fluorophores to be bound directly to the polynucleotide core or anchor may be bound prior to or after individual tile assembly. Such conditions can be determined by those of skill in the art. Preferably, each individual encoding and linker tile is self assembled separately.

In one embodiment, each individual tile after assembly presents one or more “sticky ends” to which only an appropriately designed different tile can be annealed. For example, the encoding tiles can be designed so that their sticky ends can only base pair with sticky ends on linker tiles. Thus, the encoding tiles and linking tiles can then be incubated under conditions suitable to promote binding of the sticky ends to produce a desired tiling array. For example, in embodiments where the encoding tiles comprise fluorophores, two separate populations of encoding tiles can be mixed at different ratios (in separate tubes) together with an equal amount of linker tiles to produce a tiling array system comprising tiling arrays of various barcodes. In a non-limiting example, the assembly of the combinatorial encoding nucleic acid tiling array system includes the following steps: 1) A1 tile (“red” dye labeled) and A2 tile (“green” dye labeled) are annealed separately, and then mixed together at various molar ratios in different tubes to generate a combinatorial series of barcoded mixtures, e.g. 3R0G, 2R1G, 1R2G, and 0R3G; 2) Different probes all labeled by the same “blue” dye are annealed into B tiles in different tubes; 3) By mixing the A tiles with the B tiles one to one correspondingly in a separate tube with a ratio of (A1+A2):B=1:1, the A tiles will associate with the B tiles to grow into 2-D arrays. With this approach, a modular system of encoding arrays is set up, with each array carrying a unique probe and displaying a unique barcode color; 4) All of the barcoded arrays are mixed together at room temperature to form the multiplexed detection system. The different array domains, each carrying a unique probe, will remain separated and co-exist in a single solution. Those of skill in the art will recognize many variations in the methods for making the tiling arrays, based on the disclosure herein.

The methods disclosed herein for making the nucleic acid tiling arrays of the invention provide for rapid and inexpensive fabrication of custom arrays. A 100 nmole-scale DNA synthesis yields>10¹⁰ arrays (assuming ˜10×10 μm² in dimension for each array). A cost per array (labeled with fluorescent dyes) is about 40 nanodollars. Many different types of arrays can be made modularly with small changes to the component DNA polynucleotides/tiles, so the cost of further development of new types of array is very small.

The methods for making the tiling arrays also provide accurate control of spatial distance between probes allows efficient binding kinetics. The rigidity and well-defined geometry of nucleic acid tile structures provide superb spatial and orientational control of the probes on the array. The spacing of the probes and their positioning with respect to the tile array surface can be precisely controlled to the sub-nanometer scale. This not only allows optimization of geometry for fast kinetics, it also allows efficient rebinding of the target to nearby probes and leads to improved binding efficiency. The sample is ready for imaging within 30 minutes after addition of the targets. The well separated positioning of the probes on the array also avoids quenching between dyes.

In embodiments where nucleic acid probe is bound to the array, no bio-conjugation steps are necessary for probe attachment. Probes (either DNA, RNA or aptamer oligos) are partially hybridized to the nucleic acid tile in the array through hydrogen bonding of base pairs. Upon target binding, fluorophore-labeled probe is either released from the nucleic acid array to reveal a negative signal change or the target binding brings in another fluorophore-labeled reporter probe for positive signal change. No covalent bonding process is involved in this process. This significantly reduces steps and cost in the detection system preparation, compared to the chip or bead-based technologies. For the same reason, the detection system is also rechargeable, because after each round of detection, additional probes can be added to the solution of the array and rehybridized into the array for the reuse of the detection system.

In another aspect, the present invention provides methods for detecting presence of one or more targets in a sample, comprising
(a) contacting a probe-containing combinatorial nucleic acid tiling array or probe-containing combinatorial encoding nucleic acid tiling array system of the invention with a test sample under conditions suitable for binding of the one or more probes to its target if present in the test sample and under conditions suitable for causing displacement of the probe from the anchor by the target; and
(b) detecting a change in a fluorescence emission pattern from the combinatorial nucleic acid tiling arrays or combinatorial encoding nucleic acid tiling array system caused by displacement of the probe from the anchor, wherein the change in fluorescence emission pattern indicates presence of the target in the test sample.

As discussed herein, detection of target binding is based on nucleic acid strand hybridization and displacement technology. The probes (either DNA, RNA or aptamer oligos) are partially hybridized to the DNA tile in the array through hydrogen bonding of base pairs. Upon target binding, a fluorophore-labeled probe is either released from the array to reveal a negative signal change or the target binding brings in another dye-labeled reporter probe for positive signal change. The detection system is also rechargeable, because after each round of detection, additional molecular probes can be added to the solution of the array and rehybridized into the array for the reuse of the detection system.

Examples of test samples include, but are not limited to, purified ligand, ligand mixtures, cell lysates, cell culture medium, environmental samples (collected from any external source either directly in the case of a body of water or indirectly by filtering, washing, grinding or suspending in the case of solid or gaseous environmental samples), protein extracts, tissue samples, pathology samples, bodily fluid samples including but not limited to blood, urine, semen, saliva, vaginal secretions, and sweat.

Any means in the art for detecting fluorescence from the signaling aptamer upon binding to the ligand of interest can be used, as disclosed in, for example, WO2006/124089.

When used with embodiments of the array comprising multiple probe populations, the methods of the invention provide simultaneous detection of various biomolecular species. The methods provide the ability to detect DNA, RNA, protein and/or other small molecules together from a single solution. Aptamers are short sequences of DNA or RNA oligos that have been selected to bind with a variety of molecules or species, and can be used as probes as discussed above. In one embodiment different encoded tile arrays can each carry a unique aptamer sequence as probes so that the presence of multiple aptamer binding species in a mixture can be detected simultaneously. The methods provide moderate to high multiplexing capability (easily over 20 using organic dyes and up to 10⁴ using QDs) and sensitivity (pM-fM detection limit). All embodiments of the tiles, tiling arrays, and tiling array systems disclosed above can be used in conjunction with the methods disclosed here. Further details on methods for using the nucleic acid tiling arrays are provided above and below.

In another aspect, the present invention provides a finite nucleic acid tiling array, comprising a plurality of nucleic acid tiles joined to one another via sticky ends, wherein each nucleic acid tile comprises one or more sticky ends, and wherein a sticky end for a given nucleic acid tile is complementary to a single sticky end of another nucleic acid tile in the nucleic acid tiling array; wherein the nucleic acid tiles are present at predetermined positions within the nucleic acid tiling array as a result of programmed base pairing between the sticky ends of the nucleic acid tiles, wherein a plurality of the nucleic acid tiles further comprise a nucleic acid probe adapted to bind to a signaling aptamer, wherein the nucleic acid probe is attached to the core polynucleotide structure. In one embodiment, each nucleic acid probe (and the signaling aptamer it is adapted to bind to) is unique to the nucleic acid tile on which it is found. In another embodiment, each nucleic acid probe (and the signaling aptamer it is adapted to bind to) is identical to the nucleic acid probes present on other nucleic acid tiles in the tiling array. In a further embodiment, some of the nucleic acid probes on the array are unique while others are identical to the nucleic acid probes present on other nucleic acid tiles in the tiling array. In a further embodiment, the nucleic acid tiling arrays further comprise signaling aptamers bound to one or more of the nucleic acid probes on the nucleic acid tiling array.

Signaling aptamers, nucleic acids, and nucleic acid tiles are as discussed above. As used in this embodiment, the term “ligand” includes proteins, lipids, carbohydrates, nucleic acids, or other molecules. In this embodiment, each “nucleic acid tile” comprises (a) a structural element (also referred to herein as the polynucleotide “core”) constructed from a plurality of nucleic acid polynucleotides and (b) 1 or more “sticky ends” per nucleic acid tile attached to the polynucleotide core. As used herein, a “sticky end” is a single stranded base sequence attached to the polynucleotide core of a nucleic acid tile. For each sticky end, there is a complementary sticky end on a different nucleic acid tile with which it is designed to bind, via base pairing, within the nucleic acid tiling array.

As used in this aspect, the term “nucleic acid probe” refers to nucleic acid sequences synthesized as part of one or more polynucleotide structures in a nucleic acid tile that does not participate in base pairing with other polynucleotide structures within a nucleic acid tile or with adjacent nucleic acid tiles in a nucleic acid tiling array (See, for example, the detailed discussion in WO2006/124089). Thus, the nucleic acid probe is available for interactions with signaling aptamers to which it binds directly or indirectly. The use of nucleic acid probes as disclosed herein and in WO2006/124089 allows a wide variety of discrete molecules to be placed at precise locations on the nucleic acid tiling array with nm-scale accuracy. In a preferred embodiment, the nucleic acid probe comprises a DNA probe. Those of skill in the art will understand that while the nucleic acid tiling arrays of this aspect comprise nucleic acid probes adapted for binding to signaling aptamers that there may be additional nucleic acid probes on the array that are adapted for binding to other targets including, but not limited to, nucleic acids (RNA or DNA), polypeptides (including both natural proteins and peptides as well as other amide linked linear and branched heteropolymers), lipids, carbohydrates, other organic molecules, inorganic molecules, metallic particles, semiconductor particles, nanotubes, nanofibers, nanofiliaments, other types of nanoparticles, magnets, quantum dots, and combinations thereof. Thus, in a further embodiment, the nucleic acid tiling arrays further comprise a plurality of other targets bound to nucleic acid probes specific for those targets on the signaling aptamer arrays disclosed herein.

The particular nucleic acid probe sequences, length, or structure are not critical to the invention; the only requirement is that the nucleic acid probe be able to bind, directly or indirectly, one or more signaling aptamers, or other targets of interest in further embodiments. The nucleic acid probe may be single stranded, single stranded but subject to internal base pairing, or double stranded, and the nucleic acid probe may be of any length that is appropriate for the design of the nucleic acid tile of which the nucleic acid probe is a part, but constrained in length so that neighboring probes (either within a tile or between different tiles) do not interfere with target binding by the nucleic acid probe when such binding is desired. In an alternative embodiment, the nucleic acid probe sequence, length, and/or structure are designed to provide either or both positive cooperativity or negative cooperativity in the binding events. In one illustrative example, neighboring probes A and B can be designed so that probe A does not bind its aptamer if probe B already has aptamer already bound to it, or in which probe A only binds its aptamer if probe B is already bound to its aptamer. This embodiment can be used, for example, to provide a control network.

As used in this aspect, the term “binds” includes any covalent or noncovalent interaction that allows permanent or transient (dynamic) attachment of the signaling aptamer to the tile under the conditions of use.

As will be apparent to those of skill in the art, in this aspect, not all of the nucleic acid tiles in the nucleic acid tiling array are required to possess a nucleic acid probe. Thus, one or more of the nucleic acid tiles in the nucleic acid tiling array comprises a nucleic acid probe; more preferably a majority of the nucleic acid tiles in the array comprise a nucleic acid probe; more preferably all of the nucleic acid tiles comprise a nucleic acid probe with the optional exception of a small percentage of the nucleic acid tiles to serve as control tiles.

As will also be apparent to those of skill in the art, based on the teachings herein, the nucleic acid probe-containing tiles in an array in this aspect may all contain the same nucleic acid probe; may all contain different nucleic acid probes, or a mixture thereof. Thus, the targets for binding to the nucleic acid probes can be the same for all nucleic acid tiles in a given nucleic acid tiling array, all different, or mixtures thereof. In a preferred embodiment, each of the nucleic acid probe-containing nucleic acid tiles comprises more than one nucleic acid probe.

As used in this aspect, “addressable” means that the nucleic acid probes are at specific and identifiable locations on the nucleic acid tiling array, and thus binding events occurring at individual nucleic acid probes can be specifically measured.

In a preferred embodiment of this aspect, the nucleic acid tiling array comprises an indexing feature to orient the tiling array and thus facilitate identification of each individual nucleic acid tile in the array. Any indexing feature can be used, so long as it is located at some spot on the array that has a lower symmetry than the array itself. Examples of such indexing features include, but are not limited to:

including one or more tiles that impart(s) an asymmetry to the array;

including one or more tiles that is/are differentially distinguishable from the other tiles (for example, by a detectable label);

including any protrusion on an edge of the array that is offset from two edges by unequal amounts, which will serve to index the array even if it is imaged upside down;

including a high point on the array that is detectable;

introducing one or more gaps in the tiling array that introduce a detectable asymmetry; and

making the nucleic acid tiling array of low enough symmetry with respect to rotations and inversions that locations on it could be identified unambiguously; for example, a nucleic acid tiling array in the shape of a letter “L” with unequal sized arms would serve such a purpose.

In a further aspect, the present invention provides a two-dimensional nucleic acid tiling array, comprising a plurality of nucleic acid tiles joined to one another via sticky ends, wherein a plurality of the nucleic acid tiles further comprise a nucleic acid probe adapted to bind to a signaling aptamer, wherein the nucleic acid probe is attached to the core polynucleotide structure. In this embodiment, the nucleic acid tiling array need not be “finite”, as described above (although it can be). Other embodiments of the finite nucleic acid tiling array of the first aspect disclosed above also apply to the two-dimensional nucleic acid tiling arrays. For example, in a further embodiment, the nucleic acid tiling array further comprises signaling aptamer bound to one or more of the nucleic acid probes.

The signaling aptamer nucleic acid tiling arrays of the present invention can be contacted with a test sample thought to contain the ligand of interest under any type of conditions suitable for the desired binding event. Examples of test samples include, but are not limited to, purified ligand, ligand mixtures, cell lysates, cell culture medium, environmental samples (collected from any external source either directly in the case of a body of water or indirectly by filtering, washing, grinding or suspending in the case of solid or gaseous environmental samples), protein extracts, tissue samples, pathology samples, bodily fluid samples including but not limited to blood, urine, semen, saliva, vaginal secretions, and sweat. Appropriate conditions for promoting binding of the signaling aptamer and the ligand of interest within the test sample can be determined using routine methods by those of skill in the art. Any means in the art for detecting fluorescence from the signaling aptamer upon binding to the ligand of interest can be used, as disclosed further in WO2006/124089. All other embodiments of the nucleic acid tiling arrays as disclosed in WO2006/124089 are also applicable to the signaling aptamer arrays disclosed herein.

### Examples

### Materials and Methods for Examples 1 and 2

### Self-Assembly of Combinatorial DNA Arrays:

All DNA strands (plain DNA oligos or oligos modified with fluorescent dyes) were purchased from Integrated DNA Technologies and purified via denaturing PAGE or HPLC.

To assemble the tiles, the strands involved in each tile were mixed separately in different tubes in equal molar ratio (all 2 μM) in 1×TAE-Mg buffer (40 mM Tris-acetic acid buffer, pH 8.0, magnesium acetate 12.5 mM), then the mixtures were heated to 94° C. and cooled down slowly (over 24 hours) to room temperature. The A1 and A2 tiles share completely same DNA strand sequences. The only difference is the fluorescent labeling: cy5 on A1 and RhoX-red (Rhodamine Red™-X) on A2. The B1 to B4 tiles share the same core tile sequences, except the different probe sequences protruding out on one arm of the B tiles. The probes on B tiles are all labeled with Alexa Fluor® 488 (Alex 488).

To assemble the four differently color-encoded DNA arrays, the tiles involved in each array were mixed together in separate tubes at designated ratios (Table 2), heated to 40° C. and cooled down slowly to 4° C. The concentrations of the detection probes in each array were all 1 μM.

The four DNA arrays were then mixed together in equal volume at room temperature, yielding the multiplexed detection solution. The final concentration of the four probes was all 0.25 μM.

### Detection and Recharging of the Combinatorial Arrays:

Desired amount of detection targets were added into 10 μl multiplexed detection solution. Unless elsewhere mentioned, final concentration of detection targets was 0.5 μM for DNA targets, 6 μM for thrombin and 3 mM for ATP. The mixture was thoroughly mixed by vortexing and then incubated at room temperature for 30 min before imaging.

After detection of a specific target, in order to recharge the array for another round of detection, 0.5 μM of the corresponding strand of the detection probe was added into the array mixture.

### Fluorescence Microscope Imaging:

2.5 μl pre-mixed and incubated sample was deposited on a glass slide and immediately covered by an 18 mm² cover slip (the solution was spread over the entire covered area) for imaging.

All the fluorescence microscope images were taken using a Leica® SP2 scanning laser confocal microscope. The sample was scanned at eight confocal planes, each through the “blue”, “green” and “red” channel sequentially. The color of each channel are assigned by Leica SP2 software and may not reflect the true color of the emission. At each confocol plane, a frame of 150×150 μm² image was taken in 512×512 pixels resolution (unit pixel size 293×293 nm²) at the scanning speed of 400 Hz. Switching of the scanning channels and their corresponding set-up was controlled by a sequentially scanning program featured in the Leica SP2 software. The resulting images shown were generated by super-imposing images in three channels of each confocal plane followed by transparently stacking of the eight superimposed frames. It takes less than 1 minute to finish collecting one superimposed image.

The set-up parameters are listed in Table 3. For example, for the blue channel, excitation light at wavelength of 488 nm was generated by an Ar¹ laser, reflected by a DD 488/543 dichroic mirror and focused by an oil immersed PL APO 100.0×1.40 objective lens to irradiate the sample. The emitted photons were collected by the same objective, transmitted through the same dichroic mirror, filtered by a spectra-photometer (bandpass: 500-550 nm) and focused onto a 182 μm pinhole before reaching the detector in the blue channel. For the green and red channels, the same set-up was used except for the excitation light resource, dichroic mirror and spectra-photometer bandpass. The three dyes used have their emission spectra well separated by the bandpass filters.

TABLE 1
Probes and targets used in the detection

| Probes and | |
|---|---|
| targets | Sequences or target names |
| Probe 1 | 5′-CGTCTCTACCTGATTACTATTGCATCT-3′ |
| | (SEQ ID NO: 1) |
| Target 1 | 5′-AGATGCAATAGTAATCAGGTAGAGACG-3′ |
| | (DNA sequence of SARS virus) |
| | (SEQ ID NO: 2) |
| Probe 2 | 5′-TTTAACAGCAGTTGAGTTGATACTACTGGCCTAATT |
| | CCA-3′ |
| | (SEQ ID NO: 10) |
| Target 2 | 5′-TGGAATTAGGCCAGTAGTATCAACTCAACTGCTGTT |
| | AAA-3′ |
| | (DNA sequence of HIV virus) |
| | (SEQ ID NO: 3) |
| Probe 3 | 5′-CACTGTGGTTGGTGTGGTTGG-3′ |
| | (ATP binding aptamer sequence) |
| | (SEQ ID NO: 4) |
| Target 3 | 5′-CCAACCACACCAACCACAGTG-3′ |
| | (full complementary of probe 3) |
| | (SEQ ID NO: 5) |
| Probe 4 | 5′-CACTGACCTGGGGGAGTATTGCGGAGGAAGGT-3′ |
| | (Human α-Thrombin binding aptamer |
| | sequence) |
| | (SEQ ID NO: 6) |
| Target 4 | 5′-ACCTTCCTCCGCAATACTCCCCCAGGTCAGTG-3′ |
| | (full complementary of probe 4) |
| | (SEQ ID NO: 7) |
| Target 5 | Human α-Thrombin |
| Target 6 | ATP |

TABLE 2
DNA tiles used to self-assemble into combinatorial arrays

| Combinatorial array code | Targets | Molar ratio of the tiles |
|---|---|---|
| 3R0G3B | SARS virus DNA | A1:B1 = 1:1 |
| 2R1G3B | HIV virus DNA | A1:A2:B2 = 2:1:3 |
| 1R2G3B | Human α-thrombin | A1:A2:B3 = 1:2:3 |
| 0R3G3B | ATP molecule | A2:B4 = 1:1 |

TABLE 3
Fluorescence microscope setup parameters
in the three detection channels.

| | | | Dichroic | Emission | Emission |
|---|---|---|---|---|---|
| Channel | Dye | Excitation | mirror | peak | bandpass |
| Blue | Alexa fluor | 488 nm | DD | 519 nm | 500-550 nm |
| | 488 | (Ar) | 488/543 | | |
| Green | Rhodamine | 568 nm | DD | 590 nm | 580-640 nm |
| | Red-X | (Kr) | 488/543 | | |
| Red | Cy5 | 633 nm | TD | 665 nm | 660-750 nm |
| | | (He/Ne) | 488/543/ | | |
| | | | 633 | | |

### Example 1 Combinatorial Array Showing Detection of Various Species

We have carried out experiments to demonstrate that a) different molecular probes such as structural switching aptamers or DNA probes that each modified with one type of fluorescent dye hybridize to a DNA tile in separate test tubes and when subsequently combined together in controlled ratios, they grow into large piece of micron-size arrays with pre-defined colors; b) detection mechanism using strand displacement technique works on the array system. The detection targets can be, for example, proteins or small molecules that are recognized by the signaling aptamer, or simply a specific pathogen gene that is complementary of the molecular probe. Upon the addition of targets to the array, the probe strands are displaced from the tile array completely or partially depending on the ratio of the target added and the probes available, and the color of the array changes. This color change or the relative fluorescence intensity change can be easily detected by confocal fluorescent microscope; c) different arrays corresponding to a spectrum of barcode colors can be generated by self-assembly and distinguished by fluorescent microscope.

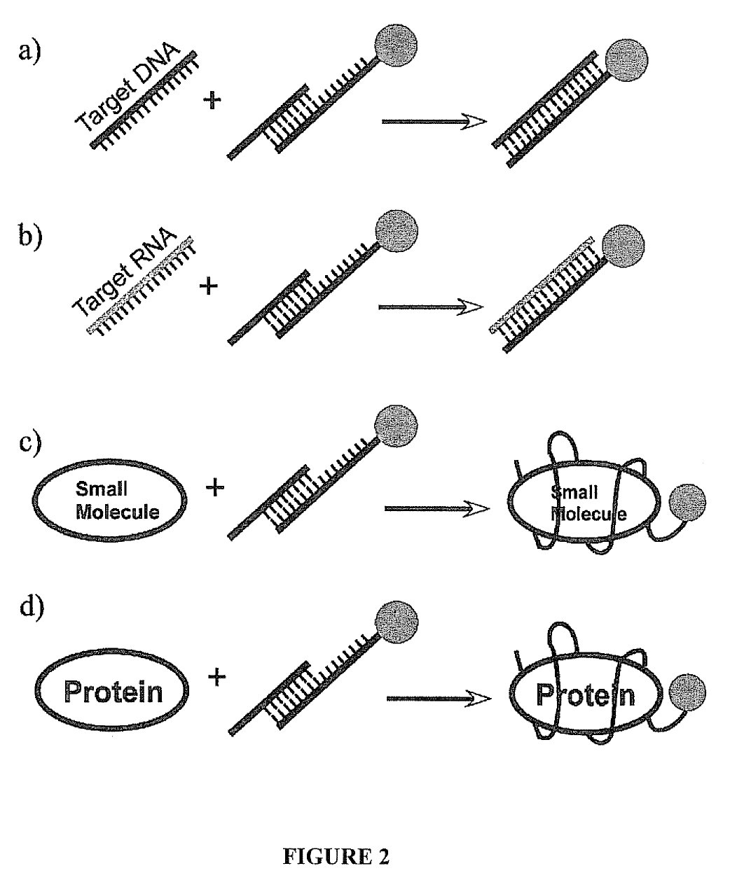

FIG. 1 illustrates the design of the preliminary version of the combinatorial detection nanoarray. Two “A” tiles (A1 and A2) are designed to have the sticky-ends that associate to the “B” tiles to self-assemble into 2D arrays. A1 is hybridized with a molecular probe carrying a “red” fluorescent dye and A2 is hybridized with a molecular probe carrying a “green” fluorescent dye. “B” tile serves as the linker tile to associate A1 and A2 into 2D array. The tiles A1, A2 and B are each formed in separate tubes and subsequently combined together into a single tube at lower temperature to form the array. By mixing the three tiles together with controlled ratio (A1:A2:B=1:1:2), the red dyes and green dyes are evenly distributed (red:green=1:1, i.e. 1R1G) in each domain of the array with equal ratios, leading to a “yellow” color for the superimposed fluorescent image. For the detection, the addition of the targets will cause a strand displacement event to happen, i.e. the molecular probe corresponding to a particular target will bind to the target and got displaced off the array (FIG. 2). The strand displacement³⁶ happens because the addition of target molecules to the solution initiated branch migration due to the stable probe-target complex, either by fully complementary base pairing or stronger binding between the aptamer and its specific target. This technology has been previously used to construct DNA based nanodevices¹¹ and controlled binding and release of thrombin protein to its aptamer³⁷. In our detection mechanism, the strand displacement event leads to a disappearance of either the red color or the green color, in turn, the array will change from “yellow” (1R1G) to “green” (0R1G) or “red” (1R0G) depending on which target is added to the system.

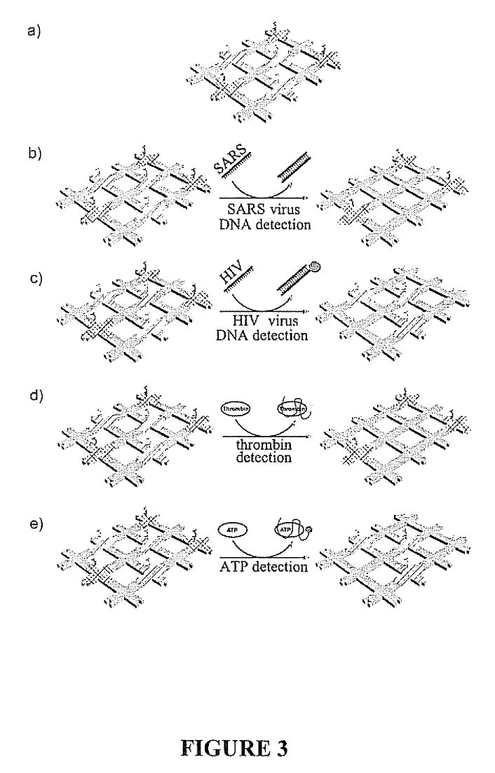

We have used the preliminary version to test the detection of 4 types of targets. The 4 targets were DNA sequence for SARS virus, DNA sequence for HIV virus, thrombin, and ATP. FIG. 3 shows the array states and detection processes (left). The data demonstrated that the detection worked as designed. When a target binds and displaces its corresponding fluorescent labeled probe, the array changes its color from yellow (FIG. 3a) to either red (FIGS. 3b & d) or green (FIGS. 3c & e). In these experiments, the concentration of the arrays was 1 μM and the concentrations for SARS DNA, HIV DNA, thrombin protein and ATP were 1 μM, 1 μM, 6 μM and 3 mM, respectively.

Since we observe the disappearance of a color from the array, we need to make sure that the disappearance of the colors is really due to the addition of the specific targets. Therefore, we performed titration experiments to verify this. Fluorescent microscope images were obtained demonstrating the titration against the 4 types of the targets described above, and it was clearly observed that when the concentration of the targets increase, the color of the array changed gradually from yellow to pure red or pure green and there were transitions between the partial binding and saturated binding of the targets and the probes.

The above titration experiment indicates that it is possible to generate a spectrum of barcodes by tuning the ratio between the red dye and the green dye. We have also tested the feasibility of generating barcodes using 2-color dyes in the self-assembled nanoarrays. Fluorescent microscope images were obtained demonstrating that barcode arrays can be formed by mixing A1 (Red) and A2 (Green) at different ratios and combining with non-fluorescent B tiles to form micron-size arrays. The barcode colors produced and imaged were red (4R0G), orange red (3R1G), yellow (2R2G), greenish yellow (1R3G) and green (0R4G).

The number of possible barcodes can be generated are limited by the number of dyes that can be used and the number of relative intensity levels can be implemented. Introducing other types of dyes with different colors requires multiple excitation wavelengths, which imposes a potential instrumentation limit. Using QDs as fluorophores to label the probes or encoding the barcodes has many obvious advantages over organic dyes: high quantum yield, high photo-stability, single wavelength excitation for QDs of different emission colors, narrow and symmetric emission spectra. Use of QDs with the combinatorial DNA tile self-assembly opens up unprecedented avenue for scaling up the multiplexed detections.

### Example 2

Another example of the self-assembled combinatorial encoding arrays is illustrated in FIG. 4. Here we utilize a previously developed AB tile system of cross-shaped tile structures (7-9), but modified the A tiles with organic dyes for spectral encoding and B tiles with single stranded probes for detection. The sticky ends of the tiles were designed in a manner such that the A tiles and B tiles separately did not associate with themselves, but when mixed, they could associate with each other alternatively to form 2-D arrays with high reproducibility and yield from the starting materials. Two subgroups of A tiles, A1 modified with a “red” dye (Cy5), and A2 modified with a “green” dye (Rhodamine Red-X), were used to perform the encoding. The B tiles accommodated the detection probes that are uniformly labeled with a “blue” dye (Alexa Fluor 488). We chose these three dyes on the basis of their spectrally unique fluorescence emission profiles (Table 3 above). With only two encoding dyes, the capacity of the multiplex detection system is determined by the number of different intensity levels in the two encoding channels (“red” and “green”) that can be distinguished by the fluorescence microscope detector.

The assembly of the multiplex detection array included the following steps: 1) A1 tile (“red” dye labeled) and A2 tile (“green” dye labeled) were annealed separately, and then mixed together at various molar ratios in different tubes to generate a combinatorial series of barcoded mixtures, e.g. 3R0G, 2R1G, 1R2G, and 0R3G; 2) Different probes all labeled by the same “blue” dye were annealed into B tiles in different tubes; 3) By mixing the A tiles with the B tiles one to one correspondingly in a separate tube with a ratio of (A1+A2):B=1:1, the A tiles could associate with the B tiles to grow into 2-D arrays. With our approach, a modular system of encoding arrays is set up, with each array carrying a unique probe and displaying a unique barcode color (data not shown); 4) All of the barcoded arrays were mixed together at room temperature to form the multiplexed detection system. The different array domains, each carrying a unique probe, will remain separated and co-exist in a single solution.

Examples of probes on the B tiles can include single stranded nucleic acid oligos for detection of DNA or RNA targets, or aptamers for specific aptamer binding molecules. Aptamers are short DNA or RNA sequences that, through an in vitro selection process, display high specificity and affinity to specific ligand molecules, such as proteins or small molecules. Similar to the single stranded nucleic acid probes, aptamers can be attached to the DNA tile array simply by a short stretch of DNA hybridization. The mechanism of the detection is through a strand displacement, as discussed above. Here the target-probe complex is released from the array surface, leaving behind the empty anchor probe on the tile. This process leads to disappearance of the “blue” color on the tile array, so that the array changes color from the “blue-masked” color into the original encoding color.

We have tested the concept of combinatorial encoding by detecting multiple DNA targets simultaneously from a single solution). Four different DNA targets were used (0.25 μM) (Table 1), two were virus sequences, and the other two were the complementary sequences of the two aptamers used. Four types of color-encoded arrays were mixed together, each carrying a blue probe on the B tile: 3R0G3B (probe1), 2R1G3B (probe2), 1R2G3B (probe3), and 0R3G3B (probe4). Upon addition of the targets individually or in different combinations of mixtures, the presence of each target revealed its own color code. Any single target can be considered as a control for the other three probes. The specificity of the multiplex detection was indicated by the lack of color change of the arrays when their specific targets are absent. Probes of different lengths are used, ranging from 21 nt to 39 nt. The number of base-pairing between the probes and the anchor strands on the tiles are also different, ranging from 8 bp to 12 bp. The detection of targets of different lengths all display similar efficiency, showing versatility of the detection system.

We have also demonstrated the use of the encoding array for multiplexed detection of aptamer binding molecules. Two different aptamer binding targets were used: human α-thrombin and ATP (See Table 1). The DNA sequences of probe 3 and 4 are, in fact, the aptamer sequences for these two targets. The existence of the targets individually or in a mixture reveals their corresponding encoding color in the array. The arrays carrying probe 1 and probe 2 do not show any color change, demonstrating the probe specificity of the multiplexed detection. As a control experiment, the existence of 6 μM of BSA protein does not lead to the color change of all the encoding arrays, showing the target specificity of the detection.

Titration experiments verify that the color changes were in fact due to the addition of the specific targets. Four different targets, including DNA oligos and aptamer binding molecules (Targets 1, 2, 5 and 6) were separately added in increasing concentrations to the corresponding encoded array. The color of the arrays changed gradually from the “blue-masked” colors to the “green-red” encoded colors, revealing clear transitions between the partial binding and saturated binding of the probes.

The probes were attached on the tile array by simple base-pairing to the anchor probes, and they were removed from the array during the detection process. This enables the recharging of the detection system. Once the detection system is used for one target detection, the probes for that target can be added to the solution to bind to the anchor probes again, so that the system can be used again for another round of detection.

A complete disappearance of the probe color can be observed only when all the probes on the tile are displaced by their corresponding targets, therefore the detection limit is related to the effective probe concentration in the detection system and the dissociation constant of the target-probe complex. The apparent dissociation constants for the aptamer binding molecules are ˜400 nM for thrombin and ˜600 μM for ATP (13), much weaker binding affinity compared to the DNA/DNA duplexes with 12 bp (K_{D} in pM range). Thus, higher concentrations of these two aptamer targets are needed to get the similar amplitudes of color change in comparison to DNA/DNA duplexes. To further refine the detection sensitivity, we can use lower concentration of the probes and optimize the affinities between the probes with their aptamer targets.

We performed a test to detect lower amounts of the four DNA targets by diluting the arrays to 5 nM. The appearance of four different encoding colors after addition of 5 nM of each DNA targets indicated that it is possible to lower the detection limit by diluting the tile arrays.

When performing color change detection of the arrays by fluorescence microscopy, we spread out the sample (1 μL) to the whole surface area of a cover slip. In this case, we sometimes had to manipulate the sample stage to locate all the different arrays, which limited the throughput of the detection. It is preferred to confine the sample deposited on the surface to a sub-millimeter area, which would allow sub-pM to fM detection sensitivity for DNA targets to be achieved. It is also possible to design a detection mechanism using positive signal change schemes and signal amplification techniques, such as hybridization chain reaction (14) on the encoding array, to achieve higher sensitivity.

In summary, we have described a new methodology utilizing DNA tiles to direct the self-assembly of fluorescently labeled molecular probes into water-soluble combinatorial encoding arrays for multiplexed detection. The new approach developed here directly addresses some critical challenges in the simultaneous and efficient detection of biological species. Here we have used organic dyes as fluorescent labels to demonstrate the encoding array. By using quantum dots as fluorescent labels, one can scale up the multiplexing capability of the array. We expect the system developed here will open up new opportunities for the detection of a variety of critical cellular biomarkers, such as mRNA and cytokines.

### REFERENCES FOR EXAMPLES 1-2

1. Y. H. Yang and T. Speed, Nature Reviews Genetics 3, 579 (2002).
2. M. Han, X. Gao, J. Su, S. Nie, Nature Biotechnology 19, 631 (2001).
3. J. M. Nam, C. S. Thaxton, C. A. Mirkin, Science 301, 1884 (2003).
4. Y. Li, Y. Cu, D. Luo, Nature Biotechnology 23, 885 (2005).
5. N. C. Seeman, Nature 421, 427 (2003).
6. Y. He, Y. Tian, Y. Chen, Z. X. Deng, A. E. Ribbe, C. Mao, Angew Chem Int Ed 44, 6694 (2005).
7. H. Yan, S. H. Park, G. Finkelstein, J. H. Reif, T. H. LaBean, Science 301, 1882 (2003).
8. S. H. Park, P. Yin, Y. Liu, J. Reif, T. H. LaBean, H. Yan, Nano Lett. 5, 729 (2005).
9. C. Lin, E. Katilius, Y. Liu, J. Zhang, H. Yan, Angew Chem In Ed, 45, 5296-5301 (2006).
10. B. Yurke, A. J. Turberfield, A. P. Mills, F. C. Simmel, J. L. Neumann, Nature, 406, 605 (2000).
11. S. Liao, N. C. Seeman, Science 306, 2072 (2004).
12. W. U. Dittmer, A. Reuter, F. C. Simmel, Angew Chem Int. Ed. 43, 3550 (2004).
13. R. Nutiu, Y. Li, J. Am. Chem. Soc. 125, 4771-4778 (2003).
14. R. M. Dirks, N. A. Pierce, Proc. Natl. Acad. Sci. USA, 101, 15275 (2004).

### Example 3

### Nucleic Acid Tiling Arrays Containing Signaling Aptamers

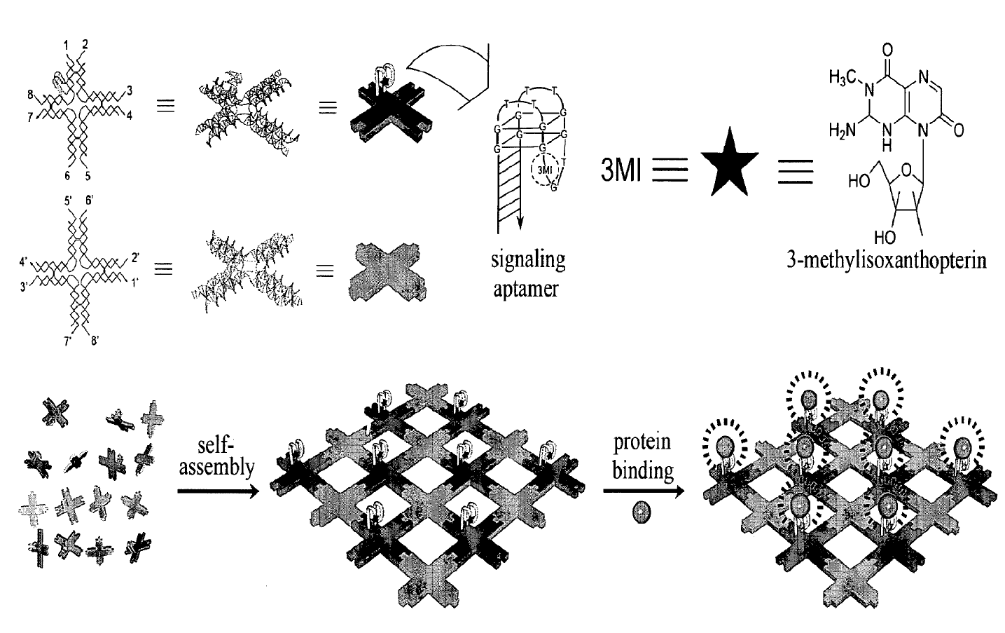

The design and prototype system: FIG. 5 schematically illustrates the design of the array based on a 2-tile system (A & B tiles), that are designed to associate with each other in a periodic fashion to form 2D nanogrids[25]. In this work, a DNA hairpin-loop containing the sequence of thrombin binding signaling aptamer is incorporated in the A tile, protruding out of the tile plane. The periodical spacing between neighboring signaling aptamers is ˜27 nm in the self-assembled array (FIG. 5b). TBA is a well characterized 15-mer DNA aptamer with a consensus sequence of d(GGTTGGTGTGGTTGG) (SEQ ID NO: 8) that folds into a unimolecular guanine quadruplex and displays about 10 nM apparent dissociation constant to human α-thrombin[26,27]. Here we used the TBA modified with 3-methylisoxanthopterin (3MI) at the position 7 (FIG. 5b). The fluorescence quantum yield of 3MI, a fluorescent guanosine (G) analog, is highly sensitive to changes in the local environment, in particular the extent of base stacking interactions[28]. Crystal structure analysis [29] of TBA bound to thrombin suggests that dT₇ undergoes a significant unstacking from the neighboring bases upon binding to the protein. Therefore the 3MI modified TBA showed a large fluorescence intensity change upon binding with thrombin. 3MI has a relatively large Stoke shift with excitation and emission maxima at 350 nm and 430 nm, respectively, suitable for fluorescence imaging using a confocal fluorescence microscope. In comparison to other reported signaling aptamers, 3MI-modified aptamers have the advantage of a substantial fluorescence signal increase upon protein binding, no decrease in binding affinity, and importantly, high resistance to photobleaching [28].

Experimental results for the prototype system: Fluorescence spectra were measured at two different DNA array concentrations suspended in buffer solution to investigate 3MI fluorescence intensity changes as a function of human α-thrombin concentration. With a constant concentration of the DNA arrays equivalent to 1 μM TBA, as the thrombin concentration in solution increases from 0 to 1.6 μM, a two-fold increase in the 3MI fluorescence intensity was observed. The emission peak was also red-shifted ˜4 nm from 413 nm to 417 nm. A fit to ‘Langmuir model’ for the fluorescence response curve gives an apparent dissociation constant of ˜4±2 nM. This is obtained by taking into account the depletion of bulk concentration of protein due to binding to aptamer, and with the assumptions that (1) there is a linear fluorescence response with the concentration of the bound protein, (2) a single binding site for a 1:1 ratio of protein and aptamer, and (3) no interactions between individual binding sites. This dissociation constant is a ˜2.5 fold increase over the published effective dissociation constant values for TBA, ˜10 nM [30,31]. A detection limit was estimated to be ˜20 nM of protein based on the signal to noise level. When the concentration of the DNA array is lowered to 10 nM, the addition of human α-thrombin causes ˜60% fluorescence increase at a saturation concentration ˜30 nM. A detection limit was estimated to be ˜5 nM. The better sensitivity for the lower DNA nanoarray concentration is due to the lower background signal from the signaling aptamer alone. But as the overall signal level decreases, the signal/noise (S/N) ratio also decreases significantly.

Arrays were assembled and deposited at the effective concentration of 1 μM TBA, some aggregation of arrays was observed. This is because no terminal tiles were included in the assembly of the arrays, and thus the final arrays formed are all irregular shaped with “sticky edges”. Therefore touching of the edges of nearby DNA arrays or even some overlapping or folding of DNA arrays upon binding to the surface is common [10,11]. This phenomenon can also be observed by atomic force microscopy imaging (AFM) for the self-assembled signaling aptamer arrays before and after the addition of thrombin. AFM images clearly show the formation of the signaling aptamer array and the protein array. However, the scan of AFM tip across surface can scratch some proteins off the array due the non-covalent interaction between the protein and aptamer. Therefore, the coverage of the protein on the signaling aptamer array does not reflect the binding efficiency of the protein to the array. It is also notable that smaller domains of the array come together to form larger aggregates which can facilitate the read out of the array by fluorescence microscope imaging.

Images of DNA arrays were obtained at 50×50 μm scale. Control experiments were performed to test the specificity of fluorescence response. First, the common serum protein BSA was added to the arrays instead of a-thrombin, and no significant fluorescence intensity change was observed. Further addition of 1 μM human β-thrombin and human γ-thrombin to the arrays causes a small increase of the signal intensity, ˜15-20%, similar to the observations in solution. Finally, when 1 μM of α-thrombin is added, the arrays ‘light-up’ as the fluorescence signal increased significantly. IgE was also used as control showing no competition of binding of IgE to the aptamer. These experiments show that the fluorescence signal increase was highly specific to the thrombin protein binding to the aptamer array. To further confirm that the fluorescence change was caused by the specific binding of TBA to thrombin, a sequence d(TTTTTT(3MI)TTTTTTTT) (SEQ ID NO: 9) was incorporated into the array instead of the TBA sequence. In this case, the DNA tile arrays can still self-assemble, but no fluorescence signal changes were detected before and after addition of the α-thrombin to the solution. Thus, the self-assembled signaling aptamer array specifically detects the presence of α-thrombin in solution. Fluorescence imaging was also performed using the DNA arrays at 1 nM effective concentration of the aptamer. Dilution of the arrays one thousand times from 1 μM minimizes their aggregation, allowing single arrays be resolved. Imaging of arrays under these conditions showed that most of them exist in sizes ranging from 1 to 10 micrometers, as limited by the self-assembly process. An approximately 100% increase in the average fluorescence signal intensity was obtained from images taken in the absence and in the presence of thrombin protein. The average intensity of arrays before addition of protein range from 130 to 190 counts/μm2, while average intensity when 1 nM thrombin is added increases to 300-400 counts/μm2. This data may seem to contradict the fluorescence data obtained in solution. With the dissociation constant of ˜4±2 nM, at 1 nM initial concentration of both the protein and aptamer, the percentage of aptamers having a protein bound is expected to be lower than 20%, thus a maximum 20% increase in the signal is expected based on this calculation. Previous data have indicated the binding of TBA with thrombin maybe very complicated, 1:1, 1:2, 2:1 and 2:2 binding ratios are all possible[24,32]. Therefore the dissociation constant of 4 nM obtained by fitting the data to the simple Langmuir model may not be accurate. In addition, when the aptamers are assembled into nano-arrays, the dissociation of bound protein from the aptamer array is different from that of individual aptamer molecules in solution. Because of re-absorption of the released protein by a nearby aptamer on the array (avidity), the effective dissociation constant may decrease a order of magnitude or more. The data obtained support this argument. This ligand re-binding phenomenon has been examined theoretically on cell membrane surfaces and macromolecule systems[33,34]. It has been pointed out that re-binding can play a major role in the performance of surface-based biosensors. These results show that by incorporating the 3MI-modified signaling aptamer on DNA nanoarrays and imaging with confocal microscope, we can effectively detect nanomolar and sub-nanomolar concentrations of target protein in the solution.

Summary: We have demonstrated that the DNA tile directed self-assembly of a signaling aptamers into micron-size DNA arrays can be used to detect proteins with high specificity and sensitivity at sub-nM concentration. However, the levels of signals that were detected allow us to conclude that even picomolar concentrations should be easily detectable if signaling aptamers with higher affinity are selected. This methodology could present future opportunities to construct water-soluble sensor arrays in a programmable fashion. Using fluorescent nucleotides as fluorophores for signaling aptamers may limit the possibility of multiplexing the assay. Alternatively, different signaling aptamers that are labeled with fluorophores that emit at different wavelengths can be incorporated into the same DNA array (e.g. a multi-tile system) for multi-color and multi-target detection.

### REFERENCES FOR EXAMPLE 3

[1] N. C. Seeman, Nature 2003, 421, 427-431.
[2] E. Winfree, F. Liu, L. A. Wenzler, N. C. Seeman, Nature 1998, 394, 539-544.
[3] T. H. Labean, H. Yan, J. Kopatsch, F. R. Liu, E. Winfree, J. H. Reif, N. C. Seeman, J. Am. Chem. Soc. 2000, 122, 1848-1860.
[4] C. D. Mao, W. Q. Sun, N. C. Seeman, J. Am. Chem. Soc. 1999, 121, 5437-5443.
[5] H. Yan, S. H. Park, G. Finkelstein, J. H. Reif, T. H. LaBean, Science 2003, 301, 1882-1884.
[6] N. Chelyapov, Y. Brun, M. Gopalkrishnan, D. Reishus, B. Shaw, L. Adleman, J. Am. Chem. Soc. 2004, 126, 13924-13925.
[7] B. Q. Ding, R. J. Sha, N. C. Seeman, J. Am. Chem. Soc. 2004, 126, 10230-10231.
[8] D. Liu, M. Wang, Z. Deng, R. Walulu, C. Mao, J. Am Chem. Soc. 2004, 126, 2324-2325.
[9] Y. Liu, Y. Ke, H. Yan, J. Am. Chem. Soc. 2005, 127, 17140-17141.
[10] Y. He, Y. Tian, Y. Chen, Z. Deng, A. E. Ribbe, C. Mao, Angew. Chem. Int. Ed. 2005, 44, 6694-6696.
[11] Y. He, Y. Chen, H. Liu, A. E. Ribbe, C. Mao, J. Am. Chem. Soc. 2005, 127, 12202-12203.
[12] E. N. Brody, M. C. Willis, J. D. Smith, S. Jayasena, D. Zichi, L. Gold, Molecular Diagnosis 1999, 4, 381-388.
[13] R. C. Conrad, L. Giver, Y. Tian, A. D. Ellington, Combinatorial Chemistry 1996, 267, 336-367.
[14] D. E. Tsai, D. J. Kenan, J. D. Keene, Proc. Natl. Acad. Sci. 1992, 89, 8864-8868.
[15] W. Xu, A. D. Ellington, Proc. Natl. Acad. Sci. 1996, 93, 7475-7480.
[16] M. Rajendran, A. D. Ellington, Combinatorial Chemistry & High Throughput Screening 2002, 5, 263-270.
[17] S. D. Jhaveri, R. Kirby, R. Conrad, E. J. Maglott, M. Bowser, R. T. Kennedy, G. Glick, A. D. Ellington, J. Am. Chem. Soc. 2000, 122, 2469-2473.
[18] S. Jhaveri, M. Rajendran, A. D. Ellington, Nature Biotechnology 2000, 18, 1293-1297.
[19] E. J. Merino, K. M. Weeks, J. Am. Chem. Soc. 2005, 127, 12766-12767.
[20] M. N. Stojanovic, D. M. Kolpashchikov, J. Am. Chem. Soc. 2004, 126, 9266-9270.
[21] R. Nutiu, Y. Li, Chemistry 2004, 10, 1868-1876.
[22] R. Nutiu, Y. F. Li, J. Am. Chem. Soc. 2003, 125, 4771-4778.
[23] R. Nutiu, Y. F. Li, Angew. Chem. Int. Ed. 2005, 44, 1061-1065.
[24] Y. Liu, C. X. Lin, H. Y. Li, H. Yan, Angew. Chem. Int. Ed. 2005, 44, 4333-4338.
[25] S. H. Park, P. Yin, Y. Liu, J. H. Reif, T. H. LaBean, H. Yan, Nano Letters 2005, 5, 729-733.
[26] R. F. Macaya, P. Schultze, F. W. Smith, J. a. Roe, J. Feigon, Proc. Natl. Acad. Sci. 1993, 90, 3745-3749.
[27] K. Padmanabhan, K. P. Padmanabhan, J. D. Ferrara, J. E. Sadler, a. Tulinsky, J. Biol. Chem. 1993, 268, 17651-17654.
[28] M. E. Hawkins, Cell Biochem Biophys 2001, 34, 257-281.
[29] K. Padmanabhan, A. Tulinsky, Acta Crystallogr D Biol Crystallogr 1996, 52, 272-282.
[30] L. C. Bock, L. C. Griffin, J. a. Latham, E. H. Vermaas, J. J. Toole, Nature 1992, 355, 564-566.
[31] N. Hamaguchi, A. Ellington, M. Stanton, Analytical Biochemistry 2001, 294, 126-131.
[32] V. Pavlov, Y. Xiao, B. Shlyahovsky, and I. Willner, J. Am. Chem. Soc. 2004, 126, 11768-11769;
[33] B. C. Lagerholm, N. Thompson, Biophysical J. 1998, 74, 1215-1228.
[34] Manoj Gopalakrishnan, Kimberly Forsten-Williams, Matthew A. Nugent, and Uwe C. Täuber, Biophysical J. 2005, 89, 3686-3700.
   The text file of the sequence listing submitted herewith, entitled “06-675-PCT.ST25.txt”, created Sep. 11, 2007, and 2,143 bytes in size, is incorporated herein by reference in its entirety.

We claim:

1. A combinatorial encoding nucleic acid tiling array comprising:
(a) a plurality of linker tiles;
(b) a plurality of encoding tiles bound to the linker tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and
(c) one or more anchors bound to the nucleic acid tiling array, wherein the anchor is designed to bind a probe of interest so that the probe is displaceable in the presence of target for the probe, wherein the one or more anchors are bound to linker tiles, encoding tiles, or both.

2. The combinatorial encoding nucleic acid tiling array of claim 1, wherein the plurality of encoding tiles further comprises one or more third encoding tiles, wherein each third encoding tile comprises a third fluorophore, wherein the third fluorophore is spectrally distinguishable from the first fluorophore, and the second fluorophore.

3. The combinatorial encoding nucleic acid tiling array of claim 1 wherein the anchor comprises a nucleic acid.

4. The combinatorial encoding nucleic acid tiling array of claim 1 wherein the nucleic acid tiling array comprises at least 9 nucleic acid tiles.

5. The combinatorial encoding nucleic acid tiling array of claim 1 further comprising one or more probe populations bound to the one or more anchors; wherein each probe population comprises one or more probes; wherein each probe in a given population is spectrally distinguishable from the probes in different probe populations; wherein each probe is labeled with the first fluorophore, the second fluorophore, the third fluorophore, or a linker fluorophore that is spectrally distinguishable from the first, second, and third fluorophores; wherein the one or more probes are bound to the anchor so as to be displaceable from the anchor in presence of target for the probe; and wherein probe displacement causes a change in fluorescence of the array.

6. The combinatorial encoding nucleic acid tiling array of claim 5, wherein the one or more probes are bound to the one or more anchors via nucleic acid hybridization.

7. The combinatorial encoding nucleic acid tiling array of claim 5, wherein each encoding tile comprises at least one anchor to which a probe is bound.

8. The combinatorial encoding nucleic acid tiling array of claim 5, wherein each linker tile comprises at least one anchor to which a probe is bound.

9. The combinatorial encoding nucleic acid tiling array of claim 8 wherein the plurality of encoding tiles do not comprise probes.

10. The combinatorial encoding nucleic acid tiling array of claim 7 wherein the linker tiles do not comprise probe or fluorophore.

11. The combinatorial encoding nucleic acid tiling array of claim 5 wherein the array comprises three or more probe populations.

12. The combinatorial encoding nucleic acid tiling array of claim 5 wherein the probe comprises a nucleic acid.

13. The combinatorial encoding nucleic acid tiling array of claim 12 wherein the nucleic acid comprises an aptamer.

14. The combinatorial encoding nucleic acid tiling array of claim 1 wherein the first fluorophore, the second fluorophore, the third fluorophore, and/or the linker fluorophore comprise quantum dots.

15. A combinatorial encoding nucleic acid tiling array system comprising a plurality of combinatorial encoding nucleic acid tiling arrays according to claim 5, wherein the plurality of combinatorial encoding nucleic acid tiling arrays comprises combinatorial encoding nucleic acid tiling arrays of different (a) probes; and (b) fluorescent barcodes, wherein a given fluorescent barcode level corresponds to a specific probe.

16. A combinatorial encoding nucleic acid tiling array comprising
(a) one or more detection tiles, wherein each detection tile comprises an anchor adapted for binding to a probe so that probe bound to the anchor is displaceable in the presence of target for the probe; and
(b) a plurality of encoding tiles bound to the one or more detection tiles via base pairing, wherein the plurality of encoding tiles comprises first encoding tiles and second encoding tiles, wherein each first encoding tile comprises a first fluorophore and each second encoding tile comprises a second fluorophore;
wherein the first fluorophore, and the second fluorophore are spectrally distinguishable.

17. The combinatorial encoding nucleic acid tiling array of claim 16, further comprising one or more probes bound the anchor, wherein the probe is labeled with a third fluorophore, and wherein the third fluorophore is spectrally distinguishable from the first fluorophore and the second fluorophore.

18. A combinatorial encoding nucleic acid tiling array system comprising a plurality of combinatorial encoding nucleic acid tiling arrays according to claim 17, wherein the plurality of combinatorial encoding nucleic acid tiling arrays comprises combinatorial encoding nucleic acid tiling arrays of different (a) probes; and (b) fluorescent barcodes, wherein a given fluorescent barcode level corresponds to a specific probe.

19. A method for detecting the presence of one or more targets in a sample, comprising
(a) contacting the combinatorial nucleic acid tiling array of claim 5 with a test sample under conditions suitable for binding of the one or more probes to its target if present in the test sample and under conditions suitable for causing displacement of the probe from the anchor by the target; and
(b) detecting a change in a fluorescence emission pattern from the combinatorial nucleic acid tiling arrays caused by displacement of the probe from the anchor, wherein the change in fluorescence emission pattern indicates presence of the target in the test sample.

20. A method for making a combinatorial nucleic acid tiling array, comprising:
(a) combining a plurality of linker tiles and a plurality of encoding tiles under conditions suitable to promote base pairing of the linker tiles to the encoding tiles via base pairing, to form an array of linker tiles and encoding tiles; wherein the plurality of encoding tiles comprises one or more first encoding tiles and one or more second encoding tiles, wherein each first encoding tile comprises a first fluorophore and each second encoding tile comprises a second fluorophore, wherein the first fluorophore and the second fluorophore are spectrally distinguishable; and wherein one or more anchors are bound to the nucleic acid tiling array, wherein the one or more anchors are designed to bind a probe of interest so that the probe is displaceable in the presence of target for the probe, wherein the one or more anchors are bound to linker tiles, encoding tiles, or both.

21. A finite nucleic acid tiling array, comprising a plurality of nucleic acid tiles joined to one another via sticky ends, wherein each nucleic acid tile comprises one or more sticky ends, and wherein a sticky end for a given nucleic acid tile is complementary to a single sticky end of another nucleic acid tile in the nucleic acid tiling array; wherein the nucleic acid tiles are present at predetermined positions within the nucleic acid tiling array as a result of programmed base pairing between the sticky ends of the nucleic acid tiles, wherein a plurality of the nucleic acid tiles further comprise a nucleic acid probe adapted to bind to a signaling aptamer, wherein the nucleic acid probe is attached to the core polynucleotide structure.

22. A two dimensional nucleic acid tiling array, comprising a plurality of nucleic acid tiles joined to one another via sticky ends, wherein a plurality of the nucleic acid tiles further comprise a nucleic acid probe adapted to bind to a signaling aptamer, wherein the nucleic acid probe is attached to the core polynucleotide structure.

23. The nucleic acid tiling array of claim 21, further comprising signaling aptamers bound to one or more of the nucleic acid probes.
